(19) United States
(12) Patent Application Publication
(10) Pub. No.: US 2003/0225866 A1
(43) Pub. Date: Dec. 4, 2003

(54) System and method for standardizing patch description creation to facilitate storage, searching, and delivery of patch descriptions

(76) Inventor: Scott C. Hudson, Erie, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/161,120

(22) Filed: May 31, 2002

(51) Int. Cl. G06F 15/177

(52) U.S. Cl. 709/221

(57) ABSTRACT

A method, and corresponding system, for controlling the generation and distribution of standardized patch descriptions. The method includes establishing a content model for patch descriptions defining acceptable data content and formatting of the patch descriptions. In one embodiment, the documents are XML documents and the content models are XML DTDs or XML schemas. The content model defines the elements, attributes, and entities that may be included in created description documents. The method continues with providing the content model to the patch generators and then receiving a patch description document from one of the generators, with the received document being created with and validated against the content model. The received patch description documents are stored, later searched on search terms based on the content model, and requested documents are delivered with a look and feel provided to the standardized patch description documents.

### BACKGROUND OF THE INVENTION

1. Field of the Invention

The present invention relates, in general, to creating and distributing patches in a computer system or network, and, more particularly, to a method, and a system of implementing the same, for creating and validating patch descriptions in a standardized manner to facilitate patch description storage, patch description searching, and patch description delivery and viewing over a communication network.

2. Relevant Background

Computer system operators or managers face the ongoing and often difficult task of determining how to fix or improve operation of a computer system that has experienced an unexpected exception or is failing to operate as designed (e.g., is experiencing errors caused by software problems or “bugs”). Instead of writing a new, complete replacement version of the software (that crashed or had bugs), the designer or developer typically retrieves one or more small additions or fixes to the original software code (i.e., patches) written to correct specific bugs. For example, when a specific bug is identified, a patch is obtained from a third party (i.e., a patch provider or source) to correct the specific problem, and the patch is installed on the computer system. Typically, patch providers keep records of patch descriptions for previously identified bugs and corresponding patches installed for each identified bug in a patch description database or file system. Then, when a bug is encountered in a system, the system operator begins efforts to fix the problem by searching these patch descriptions to identify the bug and a relevant patch to correct the problem.

As a result, a relatively important and rapidly expanding web service has developed in which patch service providers enable internal and external system operators to access, search, and view patch descriptions. The patch descriptions typically provide information on problems or bugs that can be fixed with particular software patches and provide instructions on compatibility with and installation on various computer systems. One patch service provider can have numerous users accessing the patch descriptions resulting in many thousands of patch descriptions being downloaded or viewed on a regular basis. With the growing need for patch services, there is a strong need for accurate patch description databases or files, for easy and accurate searching, and useful and helpful presentation of any viewed or downloaded patch descriptions.

Providing patch description services has proven to be a rather difficult task. For example, patches and patch descriptions are being generated for each patch service provider by numerous, often uncoordinated groups or entities, e.g., patch generators, within or outside of the patch service provider enterprise. Each of these patch generators may utilize a different standard for the content and arrangement of such content for the patch description and may store and/or deliver the patch description using a different document or file format. The patch service provider typically collects all of the patch descriptions and stores the diverse collection of patch descriptions. The stored patch descriptions may be reformatted to facilitate delivery and searching, but such reformatting or processing can be time consuming and expensive and typically does not involve organizing or supplementing content. As a result, each patch description may vary in the type of information it includes and the manner such information is provided in the patch description.

The problems in consistency in the created and stored patch descriptions results in difficulties for users in effectively searching available descriptions and for the service provider in delivering requested patch descriptions with a desirably look and feel. Searching the patch description database or file system generally involves manually entering search terms to identify a smaller number of potentially relevant patches and then selecting one or more descriptions for downloading or viewing. Presently, the searcher has to try to make educated guesses as to how a patch (and/or a corresponding bug) may have been described, which with the large number of patch descriptions being searched often results in thousands of patch descriptions being listed as potentially relevant. The searcher than has to manually sift through the results. As can be seen, the searcher is required to have skill and experience in using effective search terms or a great deal of patience to find truly relevant patch descriptions. The sifting problem is often worsened by the need for basic and non-informative delivery or display techniques presently implemented by the patch service provider to account for the differing content and arrangement of the stored patch descriptions.

Hence, there remains a need for an improved method and system for providing patch descriptions to end users of the patches in a manner that enhances the users ability to search for relevant patch descriptions and the service providers ability to display or deliver the patch descriptions to the user.

### SUMMARY OF THE INVENTION

The present invention addresses the problems involved with operating a patch repository when multiple patch authors provide patch descriptions with varying content and format, such as difficulties in providing a consistent stored patch description, enabling effective searching by patch service clients, and displaying requested patch descriptions in a manner useful to the client (or patch service provider). Briefly, a system and method is provided in which each patch generator or author utilizes a patch content manager to insure that each patch description is standardized and to this end, includes a patch validating editor which an author uses to create patch description conforms to a patch creation rule set (such as a data type description (DTD) or schema in XML embodiments). The patch descriptions are concurrently validated and stored in a generator library. A patch service provider accesses each generator library (or receives description deliveries from the generators) to retrieve the stored validated patch descriptions and stores the standardized descriptions, with or without further parsing or processing to verify the descriptions conform to the rule set.

Patch clients then access the service provider patch library via a patch search tool which is able to rapidly narrow the search results because the content of the patches and location of descriptive information is known. Requests for patch descriptions from the search results are transformed or processed from the standardized patch description content and format using a look and feel engine (such as with stylesheets and/or templates) to provide a document for transfer over a network to the client according to network protocols and with a display format or configuration useful for presenting the description information effectively to the client. As will be understood from the following description, the patch standardization method and system of the invention provides a number of benefits including more refined search results for clients, enhanced data integrity, improved ease of use of search results (e.g., readability of presented descriptions), reduced maintenance costs and issues, and increased information reuse across multiple delivery formats.

More particularly, a method is provided for controlling the generation and distribution of patch descriptions within a patch resource system, i.e., a distributed computing system. The method includes establishing or assigning a content model for patch description documents within the patch resource system defining acceptable data content and formatting of the patch description documents. In one embodiment, the documents are XML documents and the content models are XML DTDs or XML schemas. The content model defines the elements, attributes, and entities that may be included in created description documents. The method continues with providing the content model to the patch generators and then receiving a patch description document from one of the generators, with the received document being created with and preferably validated against the content model. The method includes storing the received patch description document in a patch description library and providing access to patch clients to the library. Prior to storage, the received document may be further validated or at least verified to be a well-formed document using the content model.

The method continues with receiving a search request from a patch client and then performing a search of stored patch descriptions based on search terms in the request. The search terms generally can are related to the elements and content defined by the content model. The results of the search are delivered to the patch client and a request for one of these patch description documents is received from the patch client. At this point, the method involves retrieving the request patch description document, transforming the document for delivery over a communication network to the patch client and for display on the patch client's monitor with a desired look and feel. In one embodiment, the look and feel transformation is achieved by a stylesheet processor (such as an XSLT processor) retrieving a stylesheet (such as an XSLT stylesheet) and transforming the document (such as an XML document) to a deliverable document (such as an HTML or XHTML document) with the “skin” provided by the stylesheet.

### BRIEF DESCRIPTION OF THE DRAWINGS

FIG. 1 illustrates a simplified distributed computer system utilizing standardization according to the invention at patch generators and at a patch service system to facilitate consistent storage, more effective patch client searching, and improved presentation and configuration of delivered patch descriptions;

FIG. 2 provides a more detailed view of a patch generator system, such as the patch generators of FIG. 1, including a content management tool using a validating patch description or content editor for creating validated patch descriptions according to a patch standardization rule set (such as an XML DTD or schema);

FIG. 3 illustrates an exemplary content model diagram based on a patch standardization rule set (such as the one of FIG. 2) defining and providing the elements and content of a standard patch description to be created by a patch generator; and

FIG. 4 is a flow chart showing processes performed to provide a patch service with the system of FIG. 1.

### DETAILED DESCRIPTION OF THE PREFERRED EMBODIMENTS

The invention is directed to a patch resource system (and underlying operating method(s)) in which a patch service system maintains a patch library containing standardized patch description documents and, often, the corresponding patches. The patch descriptions are known to be standardized according to a couple of key portions of the invention. First, the patch resource system includes a number of patch generator or author systems that author patches and patch descriptions all according to system-wide rule set (which has been developed as a unique feature of the invention). The rule set (or content model) is implemented with each generator system including a content management tool running a patch validating editor which retrieves rule set and provides editing screens based on the rule set for data entry. The validating editor validates the created description (e.g., in real time) and the validated patch description is stored in memory. Second, the patch service system uses a library management tool to retrieve the patch descriptions and may further process or parse the descriptions to ensure they are formed according to the rule set prior to storing them in provider patch library. The standardized documents are then searched by patch clients via a description search tool (which is significantly enhanced due to the standardized content and format of the documents). A patch presentation tool is used to prepare the standardized description documents for delivery to requesting clients, with the preparation often using stylesheets and templates to create a skin or look and feel for the description content that is unique to the patch service system and/or based on the requesting client and their needs.

The modeling method is particularly apt for use in systems that utilize markup languages, such as extensible Markup Language (XML) and Hypertext Markup Language (HTML) in object-oriented programming or computing environments. Further, typical communication protocols for digital communication networks are used for ease of explanation, such TCP/IP, HTTP, and the like used commonly for the Internet and local and wide area networks. Hence, the following description and figures explain inventive features of the method and system in conjunction with XML using Java™ or another object-oriented language and programming environment conventions. Again, many of the techniques described with respect to the method and system of the invention can be implemented using differing standards for creating documents as long as a content model defining a standard content and format for patch descriptions is included and these broader implementations are considered within the breadth of the invention.

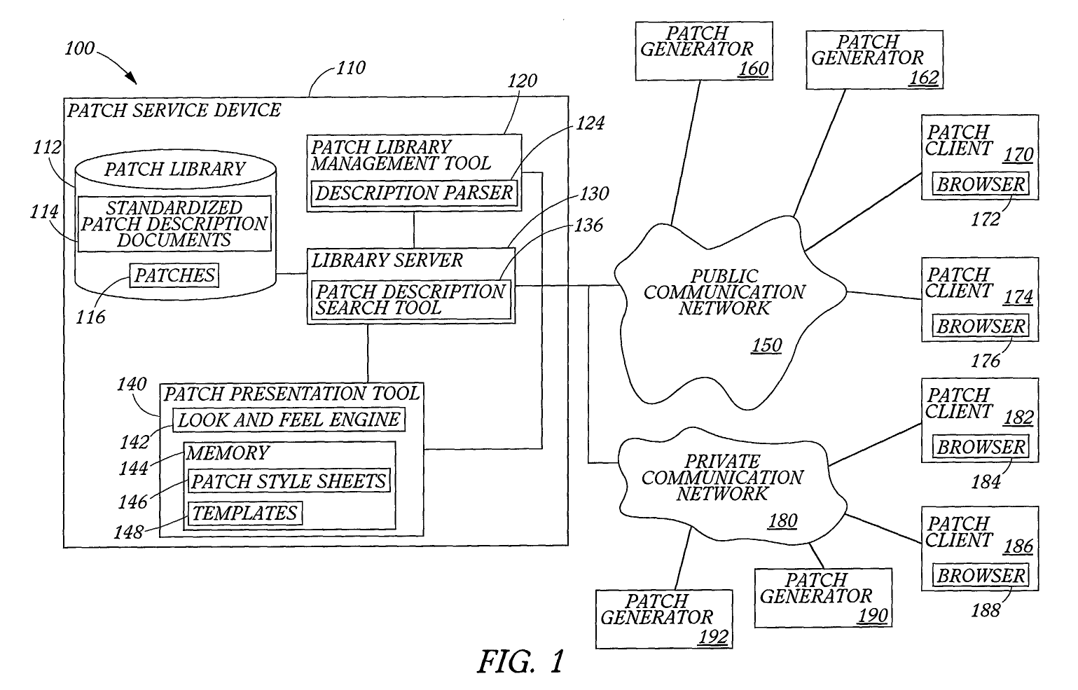

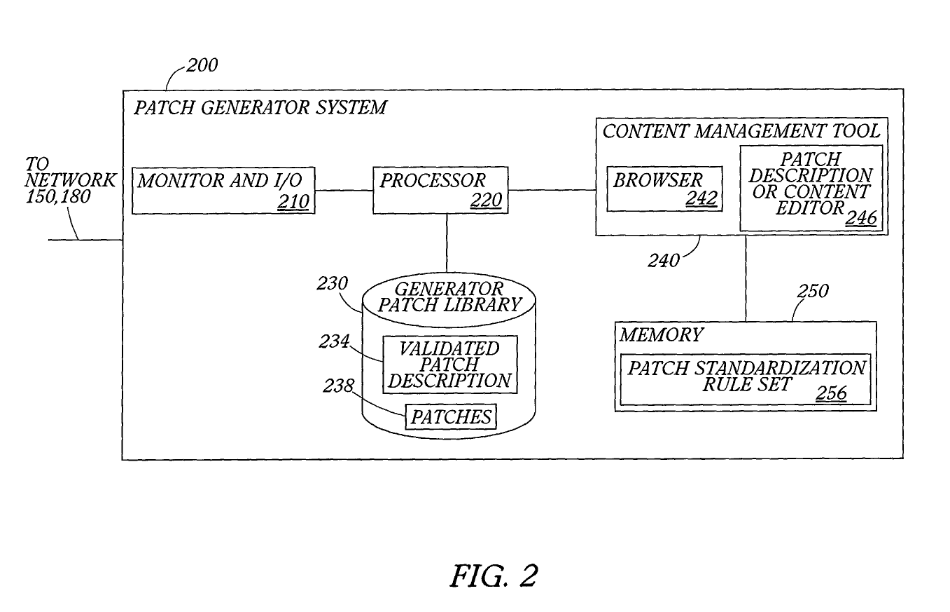

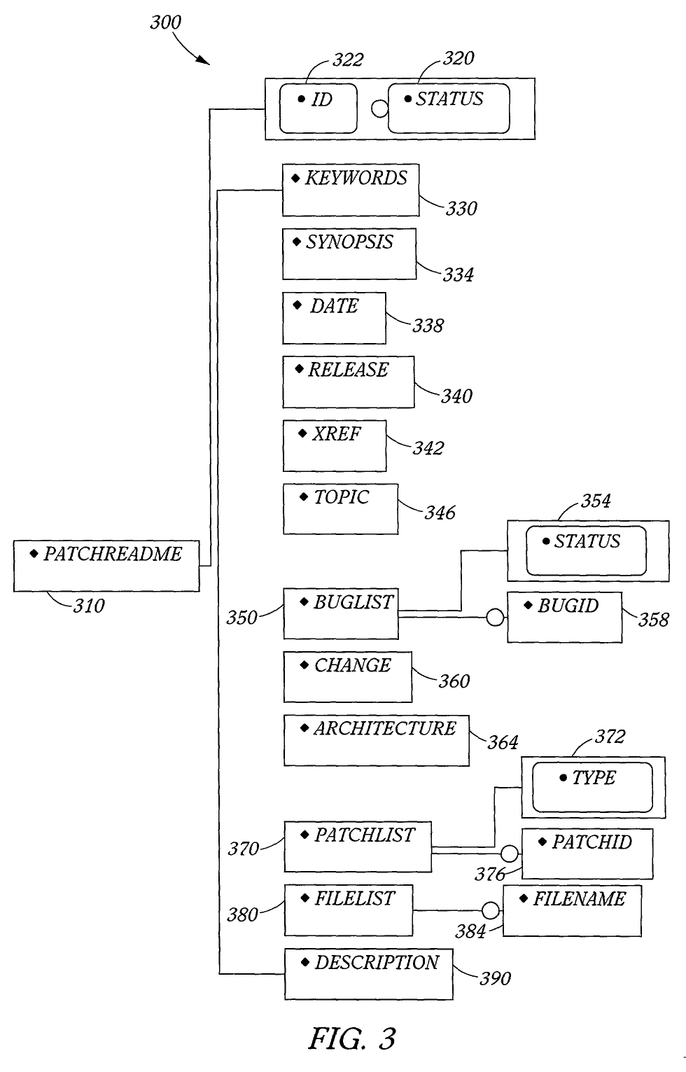

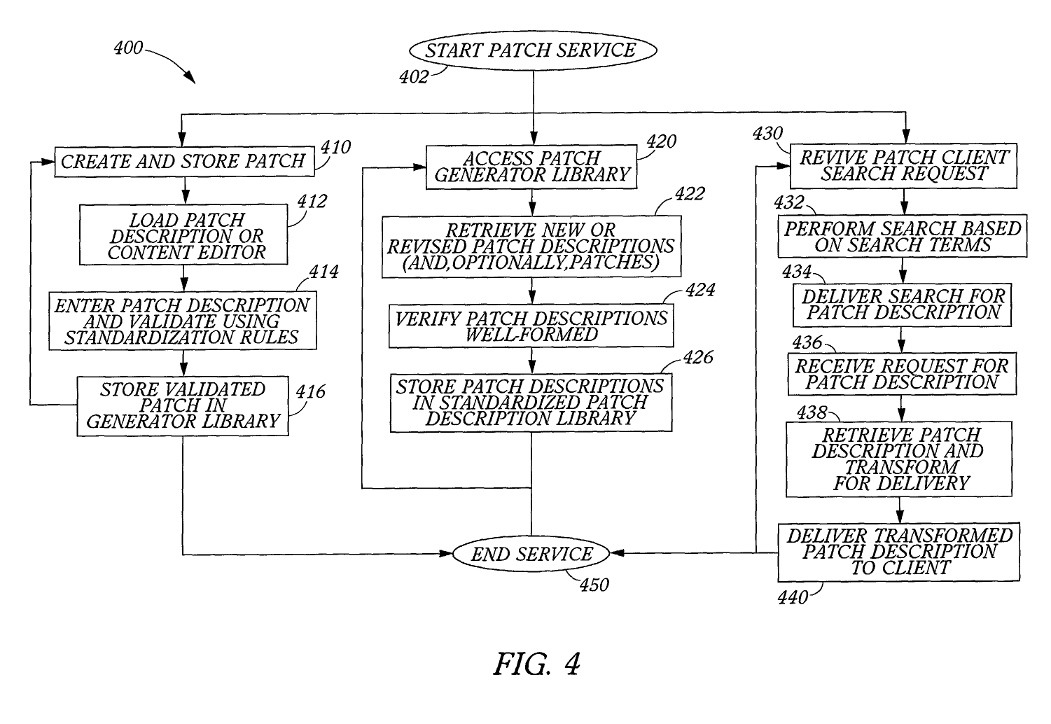

FIG. 1 illustrates a distributed computing system or patch resource system 100 illustrating generally the components (such as hardware and/or logic) that may be utilized to provide the standardized patch generation, storage, searching, and delivery functions of the invention. The functions and services of the system 100 are described in a client/server, de-centralized computer network environment with communications transmitted over a public digital communications network, such as the Internet 150 and a private network 180, such as a WAN or LAN. The description of system 100 provides a discussion of some of the important aspects of the system 100, such as the patch generators 160, 162, 190, 192 which function to generate standardized patch descriptions and the patch service system 110 which functions to gather and correlate the patch descriptions in a library 112, to provide searchable access to the descriptions, and to deliver request patch descriptions in a desired format and content. Once the exemplary and simplified system 100 is understood the discussion will proceed to a detailed discussion of a patch generator system of the invention with reference to FIGS. 2-3 and to a detailed discussion of the processes performed during operation of the system 100 with reference to FIG. 4.

In the following discussion, computer and network devices, such as patch clients and patch generators and the patch service system and its components system, and software applications and memory structures are often described in relation to their functions rather than as particular electronic devices and computer and software architectures. To practice the invention, these computer and network devices and software applications may be any devices and software useful for providing the described functions, including well-known data processing and communication devices and systems such as personal computers with processing, memory, and input/output components. Many of the network devices may be server devices configured to maintain databases or file systems and then distribute data (such as HTML or XML documents) over the data communications networks 150, 180. The communication links between the components and the communications networks 150, 180 may be any suitable data communication links, wired or wireless, for transferring digital data between two electronic devices (e.g., a LAN, a WAN, an Intranet, the Internet, and the like). In a preferred embodiment, data is communicated in digital format following standard protocols, such as HTTP, TCP/IP, and the like, but this is not a limitation of the invention as data (such as the patch description documents created by patch generators) may even be transferred on storage mediums between the devices or in print out form for later manual or electronic entry on a particular device.

As illustrated, the system 100 includes a patch service system 110 linked to public and private communication networks 150, 180 and to patch generators 160, 162, 190, 192 and patch clients 170, 174, 182, 186. The patch service system 110, generally, operates to retrieve from (or receive from) the patch generators 160, 162, 190, 192 patches and, more relevant to the invention, patch descriptions, to store the patches and descriptions, to allow the clients 170, 174, 182, 186 to search for descriptions and request specific descriptions, and to deliver transformed or reformatted descriptions to the clients 170, 176, 184, 188. Two networks 150, 180 are provided to illustrate that the patch generators 160, 162, 190, and 192 and clients 170, 174, 182, 186 may or may not be part of the same enterprise (and numerous other networks of clients and generators may be served by the patch service system 110). The existence of multiple, differing networks 150, 180 heightens the need for standardization of created and stored patch descriptions to facilitate searching and retrieving of information and the need for ways to deliver the descriptions in various formats (e.g., various looks and feels) depending on the client (e.g., based on a public versus private basis, based on an enterprise or client by client basis, and the like).

During operation by a computer network or systems manager, the patch clients 170, 174, 182, 186 access the system 110 to search and download or receive patch descriptions (and, sometimes, patches). The clients 170, 174, 182, 186 may have a number of configurations, such as being another computer system with one or more servers or simply being a personal computer or network node such as a desktop, a laptop, a notebook, or handheld computer, but typically include a browser 172, 176, 184, 188 such as a web browser program which allows them to communicate via the networks 150, 180 with the system 110 (such as by sending search requests with user-entered search terms and patch description requests) and to view patch descriptions delivered by the system 110 (such as in the form of HTML documents or XML documents wrapped within another document or transformed into a different text document or another format and then sent per communication protocols of the networks 150, 180).

According to an important aspect of the invention, patch generators 160, 162, 190, 192 are provided that function independently to create patch descriptions for the patch service system 110, and while performed independently, the patch descriptions are authored or created according a single (or in some embodiments, multiple but shared rule sets) patch description rule set. In one embodiment, the patch descriptions are authored in XML and the shared rule set is an XML schema or an XML document type definition (DTD) that is used by an include validating editor to create a validated description. The rule set is preferably selected to provide a desired arrangement of patch information and one preferred arrangement is discussed in the following description with reference to FIG. 3. The validated patch descriptions are then transferred to the system 110 or stored in the generators 160, 162, 190, 192 (or in a linked but separate data storage device or system) for later retrieval by the system 110. Each patch generator 160, 162, 190, 192 may be implemented using different hardware (such as including a database or file server and a server or other computing device providing memory and processing functions and controlling I/O and communication functions with the users and networks 150, 180) and software, as long as the described functionalities are provided. A more specific embodiment of a patch generator 160, 162, 190, 192 is provided in FIG. 2, as is discussed in detail below.

The patch service system 110 is illustrated to include a patch library 112, such as a relational database or other file system, for storing standardized patch description documents 114 and, at least in some embodiments, the corresponding patches 116. In one embodiment, the documents 114 are XML documents which make up the records of a database patch library 112. To retrieve and store the standardized patch description documents 114 (and patches 116), the system 110 includes a library server 130, such as an Oracle™, a MySQL™ server, and the like. The library server 130 typically periodically accesses the patch generators 160, 162, 190, 192 to retrieve validated patch descriptions and stores them as documents 114 in library 112. Because these are validated, standardized documents (such as XML documents created per a DTD or schema), the server 130 may simply organize the documents 114 based on the content and organization defined by the rule set (e.g., DTD or schema).

Optionally, a patch library management tool 120 is provided to initiate the patch retrievals by or in conjunction with the library server 130. The tool 120 includes a description parser 124 (such as an XML parser or parser configured for the language and/or configuration of the patch descriptions stored on the generators 160, 162, 190, 192) which can read and understand any document in the parser's language and verify that each description is well-formed, in that it meets the expected “grammar” of that particular language. The well-formed documents can then be stored and correlated by the library server 130 in patch library 112. Further, the description parser 124 may operate as a validating parser to determine that the retrieved patch description has a content and format that complies with the rule set or sets of the system 100. In this fashion, the parser 124 acts as a filter for patch generators 160, 162, 190, 192 that may have not yet adopted a rule set (and begun use of a patch validating editor), be using an out-dated rule set, or for some other reason have stored an invalid patch description. A message may than be transmitted by the management tool 120 (or other devices) to the generator 160, 162, 190, 192 informing them of the invalid patch description and other information useful for providing validated, standardized patch descriptions.

The library server 130 includes a patch description search tool 136 for processing search requests with search terms from the patch clients 170, 174, 182, 186, for querying the standardized patch description documents 114, and for creating and delivering a search result to the clients. For example, the search tool 136 may implement Oracle™, MySQL™, and other relational database search methodologies such as a middle-ware product like Enhydra™ to efficiently search the patch description documents 114 and in this regard, the tool 136. The queries performed by the tool 136 may further be facilitated by presenting a patterned or template-based search input form to the clients 170, 174, 190, 192 with entry fields based on the elements (or tags) defined by the rule set of the system 100 (such as using the tags and attributes shown in content model diagram of FIG. 3 for one exemplary rule set for the patch descriptions). In this manner, the searches can be performed more effectively (e.g., narrowed to provide relevant results) by the consistent content and location of such content in the patch descriptions.

The patch presentation tool 140 is included to process the documents 114 to create a patch description document having a desired look and feel for delivery over the networks 150, 180 to the patch clients 170, 174, 182, 186 typically for viewing on the browsers 172, 76, 184, 188. To achieve these functions, the presentation tool 140 includes a look and feel engine 142 which functions to retrieve or receive requested patch description documents 114 and transform the documents for delivery over the networks 150, 180. Generally, the look and feel engine 142 retrieves from memory 144 (or other storage space, such as one identified by an URI) patch stylesheets 146 and/or templates 148 and processes the description documents 114 prior to delivery. In this manner, the documents 114 are transformed into a document that includes information from the documents 114 with proper communication protocols (such as HTTP and TCP/IP) and configured for enhanced presentation.

In one embodiment, the patch description documents 114 are XML documents standardized to a DTD or schema (i.e., a patch rule set for the system 100). The look and feel engine 142 is or incorporates a stylesheet processor (such as an extensible Stylesheet Language Transformations (XSLT) processor based on W3C standards that define XML-compatible versions of HTML, for example, an Apache Jakarta engine known as Xalan) which transforms the XML document into an XHTML (or other document format suitable for delivery over networks 150, 180 and for viewing by browsers 172, 176, 184, 188) document for delivery with a custom “skin”. The initial result may be a result tree that is then serialized by the engine 142 into a serialized file for delivery. The engine 142 may be implemented utilizing servlets, HTML and other forms of cache, and in Java™ embodiments, XSLT and other JavaBeans™ to perform the described functions and transformations. In one embodiment, the custom skin or look and feel is provided by the stylesheets 146 (for example, XSLT or Cascading Stylesheets Levels 1 or 2 stylesheets) and/or templates 148 and is, at least in some cases, selected or paired to the patch client 170, 174, 182, 186 requesting the patch description document 114, so as to meet their business and/or customer preferences. The look and feel engine 142 is able to read the stylesheet, read the input document 114, and convert the input document 114 into an output document according to instructions given in the stylesheet 146. The engine 142 can be built into a web browser (like MSXML is built into Internet Explorer 5.5), into a web or application server, or as a standalone program. In XSLT embodiments of the stylesheets 146, the templates 148 are added to or included in the stylesheets 146 read by the engine or processor 142 to control which output is created from which input (e.g., for matching input “elements” to an output such as specific text or graphics).

An important aspect of the invention is the creation of standardized and, in preferred embodiments, validated patch descriptions by each patch generator 160, 162, 190, 192 in the system of FIG. 1 according to a rule set (e.g., a DTD or schema shared or downloaded). FIG. 2 illustrates in more detail a patch generator system 200 that may be used for generators 160, 162, 190, 192 and is connected to network 150 or 180 to enable created patches and descriptions to be delivered or retrieved by a patch supplier or repository (such as patch service system 110). As illustrated, the patch generator system 200 includes a monitor and I/O unit 210 functioning as an interface with the networks 150, 180 and for allowing an operator (i.e., a patch author) to view and enter text to create patches 238 and patch descriptions 234, which are stored in memory or generator patch library 230. A CPU or processor 220 provides processing capacity for the system 200 runs software or logic necessary to provide the description editing and validating functions described herein for the patch generator system 200.

In this regard, the content management tool 240 is provided for facilitating creation and authoring of standardized and validated patch descriptions 234. A browser 242 and, significantly, a patch description or content editor 246 (such as any validating XML editor, e.g., Arbortext Epic) to work in combination to allow an operator of the system 200 to enter a patch description per a rule set established for or by the patch reposition (see, system 110 of FIG. 1). The rule set may be stored at any location accessible by the patch generator system 200 directly or over networks 150, 180. As illustrated, a patch standardization rule set 256 is stored in local memory 250 for access by the content management tool 240 and editor 246. The rule set 256 may be a copy of a rule set maintained by a patch description provider or repository (see system 110 of FIG. 1). In some embodiments, the rule set 256 may simply provide a location of a rule set for a particular patch repository or distributed computer system (e.g., in XML embodiments, the rule set 256 is a DTD or XML schema stored at an URI and such a declaration may be provided in created patch descriptions to provide a reference rule set for parsing and/or validating created patch descriptions 234).

The browser 242 and/or validating patch description or content editor 246 may be used to create the validated patch descriptions. Either of these components 242, 246 may be employed and typically will be selected based on the particular format selected for storing the patch description (e.g., XML or other document creation language). In either case, the patch descriptions 234 are created based on the standardized rule set 256, which is built to provide a standard content for each patch description 234, typically, a standard location for such content, and preferably a shared document or file format (such as XML documents and the like).

Preferably, the patch standardization rule set 256 is designed based on typical patches 238 and the type of information that is useful by patch clients for searching and for selecting which patches 238 described in a description 234 should be loaded onto their systems. To this end, the rule set 256 may include elements or data fields including patch identifiers, keywords for searches, a synopsis or summary, an author date or revision date, a release identifier or number for operation systems and/or relevant software applications, relevant operating systems and architectures, cross references if the patch is available as part of different patches or from different patch providers, identifiers for bugs fixed by the patch, changes made to patch, patches included within this patch or replaced by this patch, files or content of the patch, a textual description of the problem fixed with the patch, and many other elements. The particular elements of data and their specific configurations and format may be varied widely to practice the invention as long as a common rule set 256 is implemented by the management tool 240 to create and store standardized and typically (but not necessarily) validated patch descriptions 234.

In one embodiment, the patch standardization rule set 256 is provided as illustrated in the content model diagram 300. The validating patch description or content editor 246 uses the rule set 256 shown in the content model diagram to create documents of a “patchreadme” type 310 with the elements and attributes shown in FIG. 3. In one embodiment, the rule set 256 is an XML DTD and in another embodiment an XML schema defining the content of each patch description 234. The XML DTD or XML schema lists all elements, attributes, and entities the document (e.g., patchreadme 310) uses and the contexts in which it uses them. The rule set 256 (such as an XML DTD or schema) may list items the document 310 does not use (with validity operating on the principle that everything not permitted is forbidden). The patch descriptions 234 are created as patchreadme documents 310. In this example, the patch description or content editor 246 is an XML parser which provides an editing window that prompts a user or operator to enter content or text for the elements of the content model 300. In a more preferred embodiment, the patch description or content editor 246 is an XML validating parser that functions not only to provide prompts for entering the elements of the model 300 but also validates the entered text in real time against the rule set 256 (e.g., such as, but not limited to, an XML DTD, an XML schema, and the like) or simply blocks invalid text from being entered. In this manner, a valid document is created with the patch description or content editor 246 and is stored as a validated patch description 234 having standard content and format defined by the rule set 256.

As shown in FIG. 3, the patchreadme document 310 includes an attribute element 320 indicating the document 310 has an ID attribute 322 with a string data type and a status attribute 324 with enumeration data type. The document 310 also includes the following elements: keywords 330; synopsis 334; date 338; release; cross reference 342; topic 346; buglist 350 (which provides a list of all bugs addressed by the patch being described which itself has a status attribute 354 with an enumeration data type and a bugID subelement 358); change 360; architecture 364; patchlist 370 (which lists all patches included and/or replaced by the patch and having a type attribute 372 with an enumeration data type and a patchID subelement 376); filelist 380 (which lists all included files and has a filename subelement 384); and description 390. The content for each of these elements is defined by the rule set 256 (e.g., XML DTD or schema) and may include text, elements, a mixture of these two, or other content as defined by the rule set 256 or underlying markup or document formatting language. The type of information that is entered for each of these elements in the document 310 are as described previously for typical patch descriptions or ways of describing patches 238. To practice the invention and provide for flexibility (while still providing a standardized patch description for a particular system 100), the particular document 310 being used to illustrate a rule set 256 or document created by following or implementing a rule set 256 may be varied by including different elements, defining the elements differently, utilizing differing attributes, and/or making other changes.

Also, in practice, a security attribute may be assigned to any element, which could be used to filter out internal or private data when the document is published to a public site. The use of security attributes enables re-use of the original content with multiple audiences depending on specific entitlements of each audience.

To build on the description of patch resource system 100 and its components, FIG. 4 illustrates a patch supply or service process 400 which illustrates operation of the system 100 with special emphasis on the benefits of providing standardized patch descriptions throughout the system 100. The patch service 400 is started at 402. At this initial step 402, one or more standardization rule sets 256 are created to provide a content model (such as the model 300 of FIG. 3) for each created patch description. Typically, a single rule set 256 is established for each patch resource system 100; however, in some embodiments, a separate rule set 256 is created for each group or set of patch clients to allow differing needs of sets of customers or users to be better met (e.g., can provide different elements, attributes, and the like based on the technical or business needs of differing sets of clients or client systems). As discussed with reference to FIGS. 2 and 3, the rule set 256 created at step 402 preferably includes elements that allow a patch creator or author to accurately yet concisely describe a created patch 238 to facilitate patch description document 114 searching by patch clients and to enable ready document 114 to delivery file or document transformation by the patch presentation tool 140. Regardless of the specific elements and attributes selected at 402, the rule set 256 is enforced for and shared by the entire system 100 and the generators 160, 162, 190, 192 so as to lead to the creation and storage of standard (and, preferably, validated) patch descriptions 230 at each patch generator 160, 162, 190, 192.

Referring again to FIG. 4, a patch generator (such as generators 160, 162, 190, 192) creates and stores a patch 238 in the generator patch library 230 (or in other patch storage) to address one or more bugs. At 412, the patch author or a separate individual(s) acts to begin creating a patch description for the created patch 238. At this point, the patch description author operates the content management tool 240 to load and/or run the patch description or content editor 246 (or browser 242) which retrieves the patch standardization rule set 256 created in step 402 (or in a separate process) and displays (such as on monitor and I/O 210) a patch description edit screen or form. The displayed editing screen is built based on the allowed elements, attributes, and entities of the retrieved rule set 256. In this fashion, the rule set 256 provides a very detailed template for entering a patch description.

At 414, the patch author operates the content management tool 240 to enter the patch description. A web browser 242 may be used but more preferably, a text editor, such as parser (e.g., an XML parser) is used to ensure that the document is created to be well-formed (i.e., to follow the underlying document language grammar and other document or file creation rules). In a more preferred embodiment, the patch description or content editor 246 uses a validating parser (such as an XML validating parser) that acts to enforce the rule set 256 (such as an XML DTD or schema or other useful rule set for defining the configuration and content of patch descriptions) in real time or concurrently with data entry such that the created patch description 234 is created as not only a well-formed document but also a document validated based on the rule set 256. The created (and preferably, validated) patch description 234 is stored in the patch generator library 416 for later delivery to or retrieval by a patch provider system 110 or patch description repository. The patch and patch description processes 410, 412, 414, and 416 (and 402 for creating the rule set 256) are repeated for each created patch and patch description at each patch generator 160, 162, 190, 192 until the service is ended at 450.

Concurrently or at any time after the generation processes (410-416), the patch service system 110 is operated to gather and organize the created patch descriptions 234. At 420, the patch service system 110 such as with the patch library management tool 120 and/or library server 130 acts to initiate communication with one or more of the patch generators 160, 162, 190, 192 to access the patch generator library 230. At 422, revised or new patch descriptions 234 are retrieved and in some cases, the underlying patches 238 are also retrieved for storage as patches 116 in the patch library 112 of the patch service system 110. In this embodiment, new or patch descriptions 234 are identified by queries or other methods and only these descriptions 234 are retrieved. In other embodiments, all descriptions 234 are periodically retrieved for storage at the patch service system 110 and existing patch description documents 114 are replaced in the patch library 112. In yet other embodiments, the patch descriptions 234 are delivered to the patch service system 110 by the patch generators 160, 162, 190, 192 as they are created and validated (after step 414) or periodically as a group of patch descriptions.

At 424, an optional step is shown of operating the description parser 124 of the management tool 120 to verify that all the received patch descriptions are well-formed per the underlying and expected document or file language. In yet other embodiments, step 424 involves the description parser 124 functioning to validate the received patch descriptions. Validating of descriptions at the patch service system 110 may be useful in situations where the patch generators 160, 162, 190, 192 are not under the direct control of the same enterprise or management as the patch service system 110, which may lead to patch generators 160, 162, 190, 192 failing to consistently adopt a rule set or in not adopting revisions to the rule set. Hence, the patch library management tool 120 can act as a standard parser (an XML parser) and/or a validating parser (an XML validating parser) so as to filter out received patch descriptions that are not comply with the rule set 256 of the system 100.

The patch service system 110 can then operate to transmit a message to the patch generator 160, 162, 190, 192 from which the non-standard patch description was received to initiate the adoption and implementation of the rule set 256 and/or content management tool 240 and the non-standard patch description can be further processed to standardize it to the rule set 256 prior to storage in documents 114 or it can simply be discarded. Standardized patch descriptions are stored at 426 in the patch description documents 114 of the patch library 112 for later access by patch clients 170, 174, 182, 186. The patch description collection processes 420-426 are performed concurrently with other processes in service 400 and on an ongoing basis or at least periodically to ensure the patch library is current with the patch generators 160, 162, 190, 192 until the service 400 is ended at 450.

Again concurrently with or at anytime after patch description creation processes 410-416 and patch description collection processes 420-426, a patch client 170, 174, 182, 186 can access the patch library 112 to search for and request delivery of patch descriptions to correct a bug or operating problem on their systems. At 430, the patch service system 110 receives a search request from a patch client 170, 174, 182, 186 such as with library server 130 and patch description search tool 136. Because the standardized patch description documents 114 have known elements and attributes defined by the rule set 256, the search request can also be well defined to provide search terms for specific elements. To further facilitate the search process 430, the patch description search tool 136 may be configured to manage a search session initiated by a patch client 170, 174, 182, 186 by requiring login and then responding by delivering a search form or template for entering search terms (such as in a Boolean or other logic arrangement) for the standardized patch description documents 114. Of course, the search form or template would be created based on the rule set 256 to include one or more defined elements (such as the elements of content model 300) and typically would be displayed and text (i.e., search terms) entered via browsers 172, 176, 184, 188. In this manner, the storing of standardized patch description documents 114 facilitates searching for relevant patch descriptions (and in one exemplary case, the results for a similar patch description search were reduced from thousands of hits to less than thirty relevant hits or descriptions 114).

At 432, the library server 130 processes the search request to use the search terms to locate relevant patch description documents 114 (again the library server 130 and search tool 136 may comprise a search engine or tool known in the field for searching file systems or databases). Because the search terms can be linked to specific elements, the search process 432 is more efficient with reduced numbers of queries (such SQL queries when the library 112 is a database structure) and reduced numbers of full document searches. At 434, the library server 130 and/or search tool 136 deliver the search results to the requesting patch client 170, 174, 182, 186 via the networks 150, 180. At 436, the patch client 170, 174, 182, 186 selects or requests one or more of the patch description documents 114 in the search result listing for delivery or viewing.

At 438, the patch presentation tool 140 functions to retrieve (via the library server 130) the requested patch description document 114 and to prepare the document 114 for delivery to the patch client 170, 174, 182, 186. The look and feel engine 142, e.g., an XSLT processor, retrieves a stylesheet 146 and if referenced by the stylesheet 146, one or more templates 148 which it uses to transform the document into a file or document adapted for transmittal over the networks 150, 180 and for viewing on the browsers 172, 176, 184, 188. In one embodiment, the documents 114 are XML documents and the stylesheets 146 are XSLT stylesheets that the look and feel engine 142 uses to create an HTML or XHTML document. In some embodiments, the patch stylesheet(s) 146 is selected for making the transformation based on the origin of the patch description request. In other words, the patch presentation tool 140 functions to customize the delivered patch request document for the requesting patch client 170, 174, 182, 186. In every case, however, the use of a standard patch description document 114 allows the patch presentation tool 140 to effectively and efficiently make the transformation from an XML or other format document to an HTML or other network and browser friendly document with a desired look and feel. At 440, the transformed patch description is delivered to the requesting patch client 170, 174, 182, or 186. The search and delivery processes 430-440 are then repeated throughout the service 400 until service termination at 450.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for creating patch description documents with a standard content and format, comprising:
providing a rule set defining for a patch description document a set of data elements with a particular content and further defining a format for the patch description document;
creating a patch description editing form based on the patch description document and including entry fields for the defined data elements;
displaying the editing form on a monitor and input device;
for a patch, receiving data input for the entry fields for the patch description document from the monitor and input device;
comparing the input data against the rule set to validate the patch description document; and
storing the patch description document with the validated input data in memory.

2. The method of claim 1, wherein the providing includes receiving the rule set over a communication network from a patch service provider.

3. The method of claim 2, further including providing the patch service provider with access to the memory for retrieval of the patch description document.

4. The method of claim 1, wherein the data elements include a list of bugs addressed by the patch, a list of other patches affected by the patch, and an identifier for the patch.

5. The method of claim 4, wherein the data elements further include data elements selected from the group consisting of search keywords, description of problem addressed by patch, list of files in the patch, intended architecture for the patch, authoring date of the patch, intended operating system for the patch, and cross reference to other ones of the patches.

6. The method of claim 1, wherein the patch description document is an extensible Markup Language (XML) document and the rule set is an XML document type definition (DTD) or an XML schema.

7. The method of claim 6, wherein the creating, displaying, receiving, and validating are performed by an XML validating parser.

8. A method of generating and delivering patch descriptions to patch clients over a data communication network, comprising:
establishing a content model for patch description documents created within a patch resource system, wherein the content model defines data content and format for the created patch description documents;
providing the content model to patch generators;
receiving a patch description document for a patch from one of the patch generators, wherein the patch description document is created based on the content model; and
storing the received patch description document in a patch library.

9. The method of claim 8, further including receiving a patch description search request from a patch client, wherein the search request includes search terms based on the content model.

10. The method of claim 9, further including performing a search of the patch library based on the search terms, preparing a search result identifying relevant ones of the patch description documents, and delivering the search result to the requesting patch client.

11. The method of claim 8, further including receiving a request for the patch description document from a patch client over a data communication network, and in response, retrieving the patch description document from the patch library, transforming the patch description document to a description file based on the communication protocol of the network and based on a selected look and feel, and delivering the transformed description file to the patch client.

12. The method of claim 11, wherein the transforming is performed using a stylesheet defining the look and feel.

13. The method of claim 12, wherein the stylesheet is selected based on the requesting patch client.

14. The method of claim 12, wherein the patch description document is an XML document and the stylesheet is an extensible Stylesheet Language Transformations (XSLT) stylesheet and wherein the transforming is performed by an XSLT processor.

15. The method of claim 8, further including at the one patch generator, validating the patch description document against the content model.

16. The method of claim 15, further including prior to the storing parsing the received patch description document with the content model to determine if the patch description document is valid.

17. The method of claim 8, wherein the patch description document is an XML document and wherein the content model is an XML DTD or an XML schema defining the elements, attributes, and entities used in the patch description documents.

18. The method of claim 17, wherein the elements are selected from the group of elements consisting of a list of bugs addressed by the patch, a list of other patches affected by the patch, an identifier for the patch, search keywords, descriptions of problem addressed by patch, a list of files in the patch, an intended architecture for the patch, an authoring date of the patch, an intended operating system for the patch, and cross references to other ones of the patches.

19. A computer system for creating, storing, and delivering patch descriptions with standardized content, comprising:
a patch library storing patch description documents in memory;
a patch generator generating validated patch descriptions and communicating the validated patch descriptions to a data communication network, wherein the patch generator comprises a content management tool adapted for creating the validated patch descriptions based on a set of patch standardization rules; and
means for receiving the validated patch descriptions and for storing the received patch descriptions in the patch library as one of the patch description documents.

20. The computer system of claim 19, wherein the set of patch standardization rules is the patch description documents are eXtensible Markup Language (XML) documents and the set of patch standardization rules is an XML document type definition (DTD) or an XML schema defining elements, attributes, and entities used in the patch description documents.

21. The computer system of claim 20, wherein the content management tool includes an XML validating parser for validating the validated patch descriptions based on the set of patch standardization rules on an ongoing basis.

22. The computer system of claim 19, further including another one of the patch generators generating additional ones of the validated patch descriptions and communicating the additional validated patch descriptions to the data communication network, wherein the another one of the patch generators comprises a content management tool adapted for creating the validated patch descriptions based on the set of patch standardization rules.

23. The computer system of claim 19, further including a library server in communication with the patch library adapted to receive a patch description search request with search terms based on the set of patch standardization rules and to perform a search of the patch library based on the search terms to locate relevant ones of the patch description documents.

24. The computer system of claim 19, further including a patch presentation tool receiving a request for one of the patch description documents from a patch client over a communication network, retrieving the requested patch description document, transforming the patch description document to a description file based on communication protocol for the communication network and based on a look and feel definition, and delivering the transformed description file to the patch client over the communication network.

25. The computer system of claim 24, wherein the transforming is performed by the patch presentation tool using a stylesheet providing the look and feel definition.

26. The computer system of claim 25, wherein the patch description documents are XML documents, the stylesheet is an extensible Stylesheet Language Transformations (XSLT) stylesheet, and the transforming is performed by an XSLT processor.
